(19) United States
(12) Patent Application Publication
(10) Pub. No.: US 2008/0250506 A1
(43) Pub. Date: Oct. 9, 2008

(54) Device for Collecting, Looking Up and Processing Data, in Particular Medical Data

(75) Inventors: Pierre Rabischong, Montoellier (FR); Yves Arnail, Belmont sur Rance (FR); Bernard Delbourg, Montpellier (FR)

Correspondence Address: EGBERT LAW OFFICES, 412 MAIN STREET, 7TH FLOOR, HOUSTON, TX, 77002, US

(73) Assignee: MEDISCS, Castelnau le Lez (FR)

(21) Appl. No.: 10/597,535

(22) PCT Filed: Dec. 20, 2004
(86) PCT No.: PCT/FR2004/050734

§ 371 Date: Jun. 23, 2008

(51) Int. Cl. H04L 9/32; G06F 7/00

(52) U.S. Cl. 726/28; 707/104.1; 707/E17.005

(57) ABSTRACT

The inventive device for collecting, looking up, and processing data, in particular medical data, includes at least one mobile computer medium for recording data, the reader/writer and, if necessary, at least one fixed computer medium for data recording. The mobile and fixed computer media are embodied in such a way that they remotely communicate with each other by the reader-writer, through a communication network, like the Internet. The mobile computer medium includes a reading/writing mechanism which makes it possible to simultaneously read data recorded thereon, and write new data, while performing entirely from the mobile medium.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention concerns a device for collecting, looking up, and processing data, in particular medical data, comprising at least one mobile computer medium for recording data, a reader-writer for the mobile medium, at least one fixed computer medium for recording data, the fixed computer medium and the mobile computer medium being capable of communicating between each other remotely, via a communication network, of the type Internet for example, by means of the reader-writer.

The major object of such an invention is to provide a mobile computer medium, for example in the form of a CD-ROM (Compact Disc-Read Only Memory) or a DVD (Digital Versatile Disc), permitting storage of medical records of a patient so that the latter can have access to it by himself, as entitled by law, from an appropriate reader.

Another object of the invention is to provide physicians with a system allowing them to more easily complete the medical records of their patients and to provide physicians, if need be, with assistance for making a diagnosis.

### BACKGROUND OF THE INVENTION

There is known, through WO 03/046827, a method and a device for storing data relating to an individual and accessing said data in a secure manner, finding application in the medical field. The device according to this patent application includes a portable data storage means (for example a CD-ROM) including a register of encrypted data and decryption means capable of decrypting said data after the entering of a key (password) by the user, a computer, to which the portable data storage means can be coupled, said computer being equipped with means allowing access to the data stored on the storage means, means capable of launching the decryption means, and means for displaying the decrypted data.

In fact, the device according to this document is designed capable of permitting the reading of a user' personal data stored on a CD-ROM, from a computer equipped with a CD-ROM reader, the securing of the data being ensured by means of their encryption and the necessity to have a password provoking their decryption.

The storing of the data on the CD-ROM is made through a remote installation comprising a “server” connected to means for creating a CD-ROM. Thus, in order to create a portable data storage means (CD-ROM), the user enters his or her personal data in a “client” computer connected to the “server” through an Internet connection, the data is sent to the “server” then toward the means for creating a CD-ROM by means of a secured connection. The data is then transformed into web pages, together with the creation of a web page containing the password allowing the user to access his or her data, then burned onto a CD-ROM or, if need be, transmitted to a database.

Thus, the device according to the document WO 03/046827 allows a user to have a CD-ROM containing personal data, then to access the latter in order to look them up, once the CD-ROM is created, from any computer equipped with a CD-ROM reader.

On the other hand, the device does not offer the possibility to the user or to a person authorized by the user, to modify directly the data stored on the CD-ROM, from any computer. It entails, for this purpose, the sending of possible complementary or rectifying data from a client computer toward the server, then the remote database on which they are finally kept, whether encrypted or not. Then, they can be looked up through the CD-ROM, by using means permitting access to the database.

Thus, the document WO 03/046827 relates, among others, to a device for storing data relating to an individual and accessing said data, by using a portable data storage means, and a database hosted by a server, in which the portable data storage means includes means capable of allowing access to the data for their lookup only, but not for their modification.

Furthermore, there is known, through U.S. 2003/040940, a medical information system comprising one or more database servers connected in a network, said servers containing the medical records of patients, as well as diverse medical data. The access to the servers is based on the use of a compact disc, of the type CD-ROM or DVD, preferably in credit card format, used as a personal health card and acting as a secured access key in order to access and communicate with the servers, via Internet.

The health card can additionally contain top priority data, being accessible directly and not requiring Internet connection to access the database hosted by one of the servers.

According to one of the possible embodiments, the entire medical record of a patient can be stored (in an encrypted form) on the CD-ROM or DVD used as a health card in order to be read or modified, from any computer equipped with a CD/DVD reader capable of reading and writing.

In order to access the data stored on the CD-ROM or DVD, an encryption/decryption software, contained on said CD-ROM or DVD, is first downloaded on the computer used, then the data is decrypted. Also, the new data is first encrypted by means of the same software, then transferred toward the CD-ROM or DVD by means of a CD/DVD reader capable of reading and writing.

Therefore, the device according to U.S. 2003/040940 requires the installation of a software application on the computer used in order to look up or modify the medical data of a patient.

Unlike the aforesaid devices, the device according to the invention permits not only to both look up and modify the data stored on the mobile data medium, in this case a CD-ROM or a DVD, but also the latter is equipped with means allowing it to be used from any computer, not requiring prior installation of a program, and permitting to restore this computer, at the end of its use, to its original state.

### BRIEF SUMMARY OF THE INVENTION

For this purpose, the invention concerns a device for collecting, looking up, and processing data, in particular medical data, as defined above, in which the mobile medium includes means permitting the reading of the data that are recorded thereon and the writing of new data, said means being capable of running entirely from said mobile medium.

One of the advantages of such a feature is for example defined by the fact that it permits optimizing considerably the follow-up of a patient by a team consisting of several persons, belonging to different medical departments or specialties, and each of them being able to access the data gathered on the same data medium that can be used from any computer.

Thus, each professional has the ability to look up and/or complete a patient's medical record with the relevant data, from his or her personnel computer, before giving the mobile computer medium to the patient, in charge of keeping it, and being able himself or herself, if he or she wants so, to access the data concerning him or her from any computer he or she chooses, at any moment he or she chooses.

Of course, even if the device according to the invention is also designed to permit to persons authorized by the patient to read his or her medical record, the data it contains should still be protected in order to prevent access thereto by any person that is not authorized by the owner of the computer media.

This objective is achieved thanks to means capable of identifying the user of the mobile computer medium and authorizing or absolutely refusing access to the data recorded thereon.

On the other hand, in order to guarantee maximum security and relevance of the recorded data, the invention also provides that the same user identification means be capable of forbidding the writing of new data on the mobile computer medium in order to protect it against writing of data by any non-authorized person, for example, the owner himself or herself, or a person that is not a physician.

The invention also provides the possibility, in case the mobile computer medium is lost, to invalidate the latter then to re-create a new one based on data that are absolutely identical with those it contained at the moment it was lost.

The latter feature entails the existence of a remote database hosted for example by a company specializing in these types of activities, said database containing a copy of the medical record of each person concerned, as well as the parameters necessary for the management of the different mobile computer media, such as usernames, notions of validity, loss, etc.

The invention will be better understood when reading the following description, referring to an embodiment given indicatively and not restrictively, and whose general architecture is schematically represented in the attached drawing.

### BRIEF DESCRIPTION OF THE SEVERAL VIEWS OF THE DRAWINGS

FIG. 1 is a schematic view of the present invention.

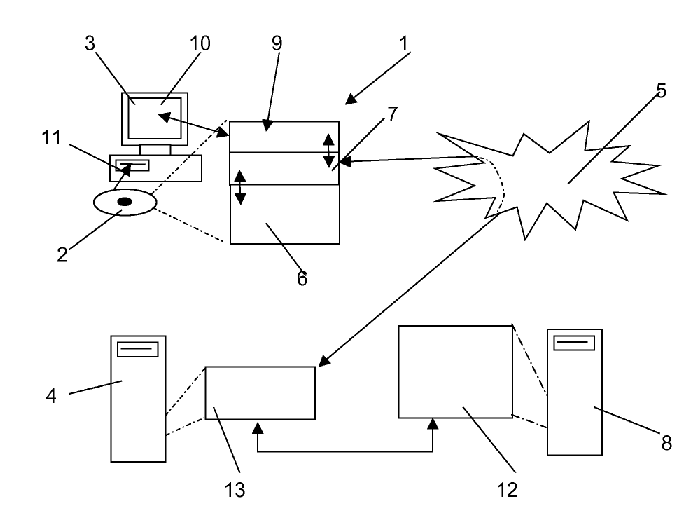

### DETAILED DESCRIPTION OF THE INVENTION

The object of the invention is a device 1 for collecting, looking up, and processing data, in particular medical data, comprising at least one mobile computer medium, in this case a CD-ROM 2, permitting to record data, a reader-writer 3 for said mobile medium 2, such as a computer and possibly at least one fixed computer medium for recording data, such as a database server 4, the CD-ROM 2 and the database server 4 being capable of communicating between each other remotely, in order to exchange data, via a communication network 5, of the type Internet for example, through the computer 3.

The first commercial versions of the device 1 will be preferably accompanied by CD-ROMs 2 of the 12 cm format that not only correspond currently to the best means combining a sufficient storage capacity with a small price, but are also compatible with most of the various types of writers equipping physicians' computers.

Of course, the device 1 according to the invention can be associated to computer media of the type DVD, the ideal being the “visiting card” format DVD combining a small size with a sufficient storage capacity, which requires however that DVD writers be provided by default according to the commercial computer configurations.

The main feature of the device 1 is defined by the fact that the CD-ROM 2 includes all means necessary for its reading and writing. In particular, the data relating to the medical record, in the form of encrypted data 6, and the application 7 necessary for both reading, writing of the medical record, as well as for communicating and sending data toward the remote database hosted by the database server 4, which contains a copy of all the data collected on the CD-ROM 2 or is connected to another server 8 containing the same copy.

Advantageously, during the insertion of the CD-ROM 2 into the reader of the computer 3 of the user, the application 7 can be launched automatically, not requiring prior installation on the same computer 3.

When the use of the CD-ROM 2 is finished, the computer 3 of the user is restored to its original state by the application 7, whose execution only requires possible writing of temporary data.

On the other hand, the application 7 is portable, preferably developed in “Java” language and capable of being executed on the most popular OSs (Operating System) (Windows xxx, MAC OS), which permits to use the CD-ROM 2 from most models of computers 3 with which professionals and private persons as well are equipped.

The application 7 is also designed to be sufficiently light so that most of the CD-ROM 2 space can be used for storing the medical record, and not for storing the application 7.

The CD-ROM 2 preferably has a client/server architecture in which the server is defined by an HTTP (HyperText Transfer Protocol) server 9 and a “servlet container”, whereas the client is defined by the default browser 10 of the computer 3, a “servlet” consisting of an application in the “Java” language hosted on the server and capable of being executed from any terminal connected to this server.

When the CD-ROM 2 is inserted in the reader 11 of the computer 3, the application 7 is started in a selected window that according to the case launches or not the HTTP server 9 and opens the browser 10 on the home page of the application 7.

In fact, thanks to the user identification means, with which the device 1 is equipped, and that imply, for example, the entering of a username, the application 7 can either authorize, or completely forbid the access to the data 6 recorded on the CD-ROM 2, or also authorize or forbid writing access thereto.

Thus, a user, such as a patient, can have access to the data 6 in order to look them up only, without being allowed to modify them, whereas another user, such as a physician has the possibility to both look up and modify said data 6, for example in order to add new data, remove, or also correct data.

Furthermore, the application 7 uses for its functioning, through “servlets”, a writing module, permitting updating of the CD-ROM 2 by recording appropriate data modifications, a module for encrypting and decrypting the data, a module for creating HTML (Hyper Text Markup Language) pages, and a module permitting communication with the database server 4, via an encrypted transmission.

More specifically, the writing module belonging to the application 7 includes two portions, of which one written in the “Java” language contained in a set of “Java” “byte code” files, and the other written in the “C” language, supplied in the form of two libraries.

The code written in “Java” is comprised of two subsets, i.e. a subset capable of creating the “ISO” (+Jolliet, etc . . . )” file that will be burned, and a subset using “Java's “Java Native Interface”, and resorting to functions in the “C” language linked to the operating system.

One of the two libraries belonging to the portion of the writing module written in the “C” language, contains the functions specific to writing (drivers, etc . . . ), and is completely linked to the operating system, whereas the other library contains functions constituting the interface between the portion written in “Java”, and the preceding library.

In fact, there are as many library pairs as there are operating systems supported by the module.

All components of the writing module, as well as of the application 7 using it, are installed on the CD-ROM 2 or, if need be, the DVD, as well as one “Java” virtual machine per operating system.

In order to write new components on the CD-ROM 2, the writing module starts by detecting the operating system on which it is installed, after which it creates in memory all “Java objects” that it requires for writing. Then it creates in memory the “ISO” file that will be burned. Then it loads in memory, and according to the operating system detected, the two required “libraries” in the “C” language. Finally, it calls up in the “libraries” the writing functions linked to the operating system, the writing being executed by default in “multisession” mode.

After this sequence of operations, the CD-ROM 2, on which the application 7 and the writing module were installed, contains the new components.

One of the purposes of the database server 4 is more specifically to host the backups of the data 6 recorded on the different CD-ROMs 2 at patients' disposal.

Thus, in case a CD-ROM 2 is lost, it is enough to re-create a new one, based on the data recorded on the database server 4.

Furthermore, each CD-ROM 2 also includes for this purpose means permitting, if necessary, to invalidate it.

The database server 4 contains or is connected to means for processing the medical data, such as, in particular, a database 12 listing symptoms and pathologies that can be used, in certain cases, for medical assistance regarding the diagnosis.

Thus, the database server 4 is designed to be able to receive, through the communication network 5, queries launched from the CD-ROM 2, and to carry out what has been requested thanks to an appropriate application 13, designed, in particular, to permit the use of medical assistance for diagnostic purposes.

We claim:

1. Device for collecting, looking up, and processing data, in particular medical data, said device comprising:
at least one mobile computer medium for recording data;
a reader-writer means for said mobile computer medium; and
at least one fixed computer medium for recording data, said fixed computer medium and said mobile computer medium being capable of communicating between each other remotely, through said reader-writer means via a communication network,
wherein said mobile computer medium is comprised of a reading/writing means, permitting both reading of the data recorded thereon and writing of new data, said reading/writing means being capable of running entirely from said mobile computer medium.

2. Device according to claim 1, wherein said reading/writing means are defined by an application comprising a writing module of which one portion is written in the “Java” language and another portion is written in the “C” language, the portion written in the “Java” language being comprised of a subset capable of creating the “Iso” designed to be burned, and of a subset using the “Java Native Interface”, whereas the portion written in the “C” language is in the form of two libraries, one of them containing the functions specific to writing and the other containing functions constituting the interface between the portion written in the “Java” language and the library containing the functions specific to writing.

3. Device according to claim 1, further comprising:
means for identifying a user of said mobile computer medium in order to authorize or to forbid reading access to the data recorded thereon, as well as to authorize or forbid writing of new data.

4. Device according to claim 1, further comprising:
means for invalidating said mobile computer medium.

5. Device according to claim 1, wherein said reading/writing means is comprised of a means for encrypting and decrypting said data.

6. Device according to claim 1, wherein said reading/writing means is comprised of means for creating HTML pages.

7. Device according to claim 1, wherein said reading/writing means is comprised of means for permitting communication between the data of said mobile computer medium and the data of the fixed computer medium.

8. Device according to claim 1, wherein said mobile computer medium is comprised of a CD-ROM.

9. Device according to claim 1, wherein said mobile computer medium is comprised of a DVD.

10. Device according to claim 1, wherein said fixed computer medium for data recording is comprised of a data-processing server containing a database.

11. Device according to claim 1, wherein said reader-writer means is comprised of a computer.
